(19) United States
(12) Patent Application Publication
(10) Pub. No.: US 2023/0146472 A1
(43) Pub. Date: May 11, 2023

(54) POLYOLEFIN COMPOSITIONS

(71) Applicant: BASF SE, Ludwigshafen (DE)

(72) Inventors: Gerard LIPS, Kaisten (CH); Daniel MUELLER, Kaisten (CH); Heinz HERBST, Kaisten (CH)

(21) Appl. No.: 17/802,901

(22) PCT Filed: Feb. 24, 2021
(86) PCT No.: PCT/EP2021/054485

§ 371 Date: Aug. 26, 2022

(30) Foreign Application Priority Data
Feb. 27, 2020 (EP) 20159823.2

(51) Int. Cl. C08K 5/17; C08K 3/26; C08K 5/32; C08L 23/12; C08K 5/3492

(52) U.S. Cl. CPC C08K 5/17; C08K 3/26; C08K 5/32; C08L 23/12; C08K 5/34926; C08K 2003/267; C08K 2003/2206

(57) ABSTRACT

The present invention relates to a polyolefin composition comprising (a) a hindered amine light stabilizer of formula (1) as defined herein, (b) a hydrotalcite or an inorganic oxide, and (c) a hydroxylamine stabilizer or an amine oxide stabilizer, a flame retardant article comprising such composition, and to the use of components (b) and (c) for reducing odor in a polyolefin composition comprising a component (a).

The present invention relates to a polyolefin composition comprising (a) a hindered amine light stabilizer of formula (1) as defined hereafter, (b) a hydrotalcite or an inorganic oxide, and (c) a hydroxylamine stabilizer or amine oxide stabilizer, a flame retardant article comprising such composition, and to the use of components (b) and (c) for reducing odor in a polyolefin composition comprising a component (a).

The present invention relates in particular to a polyolefin composition comprising (a) a compound of formula

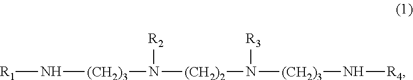

wherein R₁ and R₂ are a group of formula

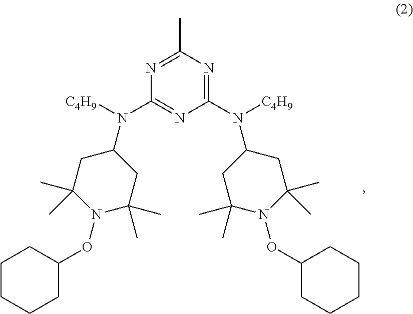

and one of R₃ and R₄ is hydrogen and the remaining one of R₃ and R₄ is a group of formula (2),

(b) a hydrotalcite or an inorganic oxide, or mixtures thereof, and

(c) a hydroxylamine stabilizer or amine oxide stabilizer.

Component (b) as a hydrotalcite is preferably a natural or synthetic hydrotalicite, especially a mixed hydroxide of the formula (b-I) or (b-II).

M₁₋ₐ²⁺Mₐ³⁺(OH)₂(A^{b-})_{a/b}x c H₂O (b-I)

M_{d}²⁺Al₂³⁺(OH)_{2d+6-eb}(A^{b-})ₑx f H₂O (b-II)

M²⁺ is for example Ca²⁺, Mg²⁺, Sr²⁺, Ba²⁺, Zn²⁺, Pb²⁺, Sn²⁺ or Ni²⁺.

M³⁺ is for example Al³⁺, B³⁺ or Bi³⁺.

a is for example a number up to 0.5.

A^{b-} is an anion of valency b, for example Cl⁻, Br⁻, NO³⁻, CO₃²⁻, SO₄²⁻ or SeO₄²⁻.

b is for example an integer from 1 to 4.

c is for example zero or a number up to 2.

d is for example a number up to 6.

e is for example a number up to 2.

f is for example zero or a number up to 15.

Hydrotalcites which are of special interest are layered double hydroxides that contain positively charged hydroxide layers and charge balancing anions located in the interlayer region.

Component b) is in particular at least one magnesium aluminum hydroxide carbonate hydrate which is for example commercially available as Hycite*713, DHT-4A©, DHT-4V©, DHT-4A-2©, DHT-4C© or Sorbacid©911, or zinc aluminum hydroxide carbonate hydrate which is for example commercially available as ZHT-4V© or Sorbacid©944, or mixtures thereof.

Of particular interest is a magnesium aluminum hydroxide carbonate hydrate which is for example commercially available as Hycite*713 or DHT-4A©.

Component (b) as an inorganic oxide is preferably calcium oxide, magnesium oxide or zinc oxide, especially calcium oxide.

For component (b) inorganic oxides are preferred.

The amine oxide stabilizer of component (c) is, for example, a tertiary amine oxide of the general formula

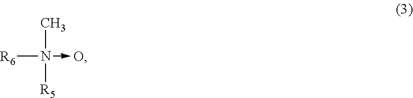

wherein R₅ and R₆, independently of each other, are C₁-C₃₀alkyl, especially C₈-C₃₀alkyl.

Most preferably, R₅ and R₆ are each independently C₁₄-C₂₄alkyl, especially C₁₆-C₁₈alkyl. In another embodiment, R₅ and R₆ are C₁₀alkyl.

The amine oxide stabilizers of the inventive polyolefin compositions may also includepoly(amine oxides). By poly(amine oxides) is meant tertiary amine oxides containing at least two tertiary amine oxides per molecule. Illustrative poly(amine oxides), also called “poly(tertiary amine oxides)”, include the tertiary amine oxide analogues of aliphatic and alicyclic diamines such as, for example, 1,4-diaminobutane, 1,6-diaminohexane, 1,10-diaminodecane, and 1,4-diaminocyclohexane, and aromatic based diamines such as, for example, diamino anthraquinones and diaminoanisoles. Also included in the present invention are tertiary amine oxides derived from oligomers and polymers of the aforementioned diamines.

Further examples of amine oxide stabilizers for component (c) are given in paragraph 6 of the list of additives given hereinafter.

The amine oxide stabilizer of component (c) is preferably a compound of formula (3), for which the above definitions and preferences apply.

The hydroxylamine stabilizer of component (c) is preferably a compound of formula

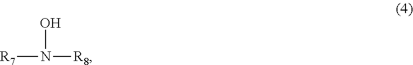

wherein R₇ and R₈, independently of each other, are C₁-C₃₀,alkyl or benzyl.

Examples of alkyl having up to 30 carbon atoms are methyl, ethyl, propyl, isopropyl, n-butyl, sec-butyl, isobutyl, tert-butyl, 2-ethylbutyl, n-pentyl, isopentyl, 1-methylpentyl, 1,3-dimethylbutyl, n-hexyl, 1-methylhexyl, n-heptyl, isoheptyl, 1,1,3,3-tetramethylbutyl, 1-methylheptyl, 3-methylheptyl, n-octyl, 2-ethylhexyl, 1,1,3-trimethylhexyl, 1,1,3,3-tetramethylpentyl, nonyl, decyl, undecyl, 1-methylundecyl, dodecyl, 1,1,3,3,5,5-hexamethylhexyl, tridecyl, tetradecyl, pentadecyl, hexadecyl, heptadecyl, octadecyl and eicosyl.

Examples of hydroxylamine stabilizers for component (c) are N,N-dibenzylhydroxylamine, N,N-diethylhydroxylamine, N,N-dioctylhydroxylamine, N,N-dilaurylhydroxylamine, N,N-ditetradecylhydroxylamine, N,N-dihexadecylhydroxylamine, N,N-dioctadecylhydroxylamine, N-hexadecyl-N-octadecylhydroxylamine, N-heptadecyl-N-octadecylhydroxylamine and N,N-dialkylhydroxylamine derived from hydrogenated tallow amine, N-octadecylhydroxylamine, N,N-dialkylhydroxylamine, N,N-di-tert-butylhydroxylamine, N-cyclohexylhydroxylamine, N-cyclododecylhydroxylamine, N,N-dicyclohexylhydroxylamine, N,N-didecylhydroxylamine, N,N-di(coco alkyl)hydroxylamine, N,N-di(C₂₀-C₂₂alkyl)hydroxylamine, N-heptatriacontyl-N-octadecylhydroxylamine.

Most preferred hydroxylamine stabilizer of component (c) are compounds of formula (4), wherein R₇ and R₈ are C₁₆-C₁₈,alkyl.

Highly preferred as component (c) are hydroxylamine stabilizers, especially those of formula (4), for which the above definitions and preferences apply.

Preference is given to compositions, wherein the weight ratio of component (a) to component (b) is 300:1 to 1:1, especially 100:1 to 1:1 and more preferably 50:1 to 1:1. Highly preferred is a ratio of 40:1 to 2:1.

Furthermore preferred are compositions, wherein the weight ratio of component (a) to component (c) is 300:1 to 1:1, especially 100:1 to 1:1 and more preferably 50:1 to 1:1. Highly preferred is a ratio of 40:1 to 2:1.

As to component (a) it is preferred to use 0.01 to 40 weight-%, especially 0.1 to 40 weight-% and more preferably 0.2 to 30 weight-% of component (a), based on the weight of the composition. Highly preferred is an amount of 0.2 to 20 weight-%.

The polyolefin is preferably polyethylene or a copolymer thereof, or polypropylene or a copolymer thereof. Polypropylene or its copolymers are preferred.

The polyethylene is preferably selected from HD-PE, MD-PE, LD-PE, LLD-PE, metallocene PE, PE-X, mixture of PE, recycled PE, bi-modal PE, PE-RT, PE 32, PE 40, PE 63, PE 80, PE 100, PE 112, PE 125, PE 100 RC, PE 100 RT and PE 100 RD, in particular from high density polyethylene (HD-PE), medium density polyethylene (MD-PE), low density polyethylene (LD-PE), linear low density polyethylene (LLD-PE), metallocene polyethylene, crosslinked polyethylene (PE-X), recycled polyethylene, bi-modal polyethylene and mixtures of polyethylenes.

Also into consideration come ethylene/propylene copolymers and mixtures of polyethylene with other synthetic polymers, like polypropylene.

In corresponding mixtures, the amount by weight of polyethylene is preferably 20 to 99.9%, more preferably 50 to 99.9%, especially 75 to 99.9%. Highly preferred is an amount by weight of polyethylene of 85 to 99.9%.

In case of copolymers the molar amount of ethylene is preferably 20 to 99.9%, more preferably 50 to 99.9%, especially 75 to 99.9%, based on the total molar amount of ethylene and propylene. Highly preferred is a molar amount of ethylene of 85 to 99.9%.

The polypropylene is preferably a polypropylene homopolymer or propylene/ethylene copolymer, or a mixture of polypropylene with other synthetic polymers, like polyethylene.

For example, the polypropylene may be categorized as atactic polypropylene (PP-at), syndiotactic polypropylene (PP-st) or isotactic polypropylene (PP-it). The density of polypropylene is preferably between 0.85 and 0.95 g/cm³, especially between 0.895 and 0.92 g/cm³.

Particularly preferred as polypropylene are polypropylene, propylene/ethylene copolymers and mixtures of polypropylene with other synthetic polymers, like polyethylene. Highly preferred are polypropylene and propylene/ethylene copolymers, especially polypropylene.

In corresponding mixtures, the amount by weight of polypropylene is preferably 20 to 99.9%, more preferably 50 to 99.9%, especially 75 to 99.9%. Highly preferred is an amount by weight of polypropylene of 85 to 99.9%.

In case of copolymers the molar amount of propylene is preferably 20 to 99.9%, more preferably 50 to 99.9%, especially 75 to 99.9%, based on the total molar amount of propylene and ethylene. Highly preferred is a molar amount of propylene of 85 to 99.9%.

The used polyolefin can be virgin or recycled material or blends thereof.

The polyolefin composition according to the present invention may further comprise one or more conventional additives such as:

1. Antioxidants

1.1. Alkylated monophenols, for example 2,6-di-tert-butyl-4-methylphenol, 2-tert-butyl-4,6-dimethylphenol, 2,6-di-tert-butyl-4-ethylphenol, 2,6-di-tert-butyl-4-n-butylphenol, 2,6-ditert-butyl-4-isobutylphenol, 2,6-dicyclopentyl-4-methylphenol, 2-(α-methylcyclohexyl)-4,6-dimethylphenol, 2,6-dioctadecyl-4-methylphenol, 2,4,6-tricyclohexylphenol, 2,6-di-tert-butyl4-methoxymethylphenol, nonylphenols which are linear or branched in the side chains, for example, 2,6-di-nonyl-4-methylphenol, 2,4-dimethyl-6-(1′-methylundec-1′-yl)phenol, 2,4-dimethyl-6-(1′-methylheptadec-1′-yl)phenol, 2,4-dimethyl-6-(1′-methylpentadec-1′-yl)phenol, 2,4-dimethyl-6-(1′-methyltridec-1′-yl)phenol and mixtures thereof.

1.2. Alkylthiomethylphenols, for example 2,4-dioctylthiomethyl-6-tert-butylphenol, 2,4-dioctylthiomethyl-6-methylphenol, 2,4-dioctylthiomethyl-6-ethylphenol, 2,6-di-dodecylthiomethyl-4-nonylphenol, thiobis-[2-tert-butyl-5-methyl-4,1-phenylene] bis[3-(dodecylthio)propionate].

1.3. Hydroquinones and alkylated hydroquinones, for example 2,6-di-tert-butyl-4-methoxyphenol, 2,5-di-tert-butylhydroquinone, 2,5-di-tert-amylhydroquinone, 2,6-diphenyl-4-octadecyloxyphenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenyl stearate, bis(3,5-di-tert-butyl-4-hydroxyphenyl) adipate.

1.4. Tocopherols, for example α-tocopherol, β-tocopherol, γ-tocopherol, δ-tocopherol and mixtures thereof (vitamin E).

1.5. Hydroxylated thiodiphenyl ethers, for example 2,2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis(3,6-di-sec-amylphenol), 4,4′-bis(2,6-dimethyl-4-hydroxyphenyl)disulfide.

1.6. Alkylidenebisphenols, for example 2,2′-methylenebis(6-tert-butyl-4-methylphenol), 2,2′-methylenebis(6-tert-butyl-4-ethylphenol), 2,2′-methylenebis[4-methyl-6-(α-methylcyclohexyl)phenol], 2,2′-methylenebis(4-methyl-6-cyclohexylphenol), 2,2′-methylenebis(6-nonyl4-methylphenol), 2,2′-methylenebis(4,6-di-tert-butylphenol), 2,2′-ethylidenebis(4,6-di-tert-butylphenol), 2,2′-ethylidenebis(6-tert-butyl-4-isobutylphenol), 2,2′-methylenebis[6-(α-methylbenzyl)-4-nonylphenol], 2,2′-methylenebis[6-(α,α-dimethylbenzyl)-4-nonylphenol], 4,4′-methylenebis(2,6-di-tert-butylphenol), 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methyl-phenyl)-3-n-dodecylmercaptobutane, ethylene glycol bis[3,3-bis(3′-tert-butyl-4′-hydroxyphenyl)butyrate], bis(3-tert-butyl-4-hydroxy-5-methylphenyl)dicyclopentadiene, bis[2-(3′-tert-butyl-2′-hydroxy-5′-methylbenzyl)-6-tert-butyl-4-methyl-phenyl]terephthalate, 1,1-bis-(3,5-dimethyl-2-hydroxyphenyl)butane, 2,2-bis(3,5-ditert-butyl-4-hydroxyphenyl)propane, 2,2-bis(5-tert-butyl-4-hydroxy2-methylphenyl)-4-n-dodecylmercaptobutane, 1,1,5,5-tetra-(5-tert-butyl-4-hydroxy-2-methylphenyl)pentane.

1.7. O-, N- and S-benzyl compounds, for example 3,5,3′,5′-tetra-tert-butyl-4,4′-dihydroxydibenzyl ether, octadecyl-4-hydroxy-3,5-dimethylbenzylmercaptoacetate, tridecyl-4-hydroxy3,5-di-tert-butylbenzylmercaptoacetate, tris(3,5-di-tert-butyl-4-hydroxybenzyl)amine, bis(4-tert-butyl-3-hydroxy-2,6-dimethylbenzyl)dithioterephthalate, bis(3,5-di-tert-butyl-4-hydroxybenzyl)sulfide, isooctyl-3,5-di-tert-butyl-4-hydroxybenzylmercaptoacetate.

1.8. Hydroxybenzylated malonates, for example dioctadecyl-2,2-bis(3,5-di-tert-butyl-2-hydroxybenzyl)malonate, di-octadecyl-2-(3-tert-butyl-4-hydroxy-5-methylbenzyl)malonate, didodecylmercaptoethyl-2,2-bis(3,5-di-tert-butyl-4-hydroxybenzyl)malonate, bis[4-(1,1,3,3-tetramethylbutyl)phenyl]-2,2-bis(3,5-di-tert-butyl-4-hydroxybenzyl)malonate.

1.9. Aromatic hydroxybenzyl compounds, for example 1,3,5-tris(3,5-di-tert-butyl-4-hydroxybenzyl)-2,4,6-trimethylbenzene, 1,4-bis(3,5-di-tert-butyl-4-hydroxybenzyl)-2,3,5,6-tetramethylbenzene, 2,4,6-tris(3,5-di-tert-butyl-4-hydroxybenzyl)phenol.

1.10. Triazine compounds, for example 2,4-bis(octylmercapto)-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris(3,5-di-tert-butyl-4-hydroxyphenoxy)-1,2,3-triazine, 1,3,5-tris(3,5-di-tert-butyl-4-hydroxybenzyl)isocyanurate, 1,3,5-tris(4-tert-butyl-3-hydroxy-2,6-dimethylbenzyl)isocyanurate, 2,4,6-tris(3,5-di-tert-butyl-4-hydroxyphenylethyl)-1,3,5-triazine, 1,3,5-tris(3,5-di-tert-butyl-4-hydroxyphenylpropionyl)-hexahydro-1,3,5-triazine, 1,3,5-tris(3,5-dicyclohexyl-4-hydroxybenzyl)isocyanurate.

1.11. Benzylphosphonates, for example dimethyl-2,5-di-tert-butyl-4-hydroxybenzylphosphonate, diethyl-3,5-di-tert-butyl-4-hydroxybenzylphosphonate, dioctadecyl3,5-di-tert-butyl-4-hydroxybenzylphosphonate, dioctadecyl-5-tert-butyl-4-hydroxy-3-methylbenzylphosphonate, the calcium salt of the monoethyl ester of 3,5-di-tert-butyl-4-hydroxybenzylphosphonic acid.

1.12. Acylaminophenols, for example 4-hydroxylauranilide, 4-hydroxystearanilide, octyl N(3,5-di-tert-butyl-4-hydroxyphenyl)carbamate.

1.13. Esters of β-(3,5-di-tert-butyl-4-hydroxyphenyl)propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.14. Esters of β-(5-tert-butyl-4-hydroxy-3-methylphenyl)propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane; 3,9-bis[2-{3-(3-tert-butyl-4-hydroxy-5-methylphenyl)propionyloxy}-1,1-dimethylethyl]-2,4,8,10-tetraoxaspiro[5.5]undecane.

1.15. Esters of p-(3,5-dicyclohexyl-4-hydroxyphenyl)propionic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.16. Esters of 3,5-di-tert-butyl-4-hydroxyphenyl acetic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.17. Amides of β-(3,5-di-tert-butyl-4-hydroxyphenyl)propionic acid e.g. N,N′-bis(3,5-di-tert-butyl-4-hydroxyphenylpropionyl)hexamethylenediamide, N,N′-bis(3,5-di-tert-butyl-4-hydroxyphenylpropionyl)trimethylenediamide, N,N′-bis(3,5-di-tert-butyl-4-hydroxyphenylpropionyl)hydrazide, N,N′-bis[2-(3-[3,5-di-tert-butyl-4-hydroxyphenyl]propionyloxy)ethyl]oxamide (Naugard®XL-1, supplied by Uniroyal).

1.18. Aminic antioxidants, for example N,N′-di-isopropyl-p-phenylenediamine, N,N′-di-secbutyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-dicyclohexyl-p-phenylenediamine, N,N′-diphenyl-p-phenylenediamine, N,N′-bis(2-naphthyl)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine, 4-(p-toluenesulfamoyl)diphenylamine, N,N′-dimethyl-N,N′-di-sec-butyl-p-phenylenediamine, diphenylamine, N-allyldiphenylamine, 4-isopropoxydiphenylamine, N-phenyl-1-naphthylamine, N-(4-tert-octylphenyl)-1-naphthylamine, N-phenyl-2-naphthylamine, octylated diphenylamine, for example p,p′-di-tert-octyldiphenylamine, 4-n-butylaminophenol, 4-butyrylaminophenol, 4-nonanoylaminophenol, 4-dodecanoylaminophenol, 4-octadecanoylaminophenol, bis(4-methoxyphenyl)amine, 2,6-di-tert-butyl-4-dimethylaminomethylphenol, 2,4′-diaminodiphenylmethane, 4,4′-diaminodiphenylmethane, N,N,N′,N′-tetramethyl-4,4′-diaminodiphenylmethane, 1,2-bis[(2-methylphenyl)amino]ethane, 1,2-bis(phenylamino)propane, (o-tolyl)biguanide, bis[4-(1′,3′-dimethylbutyl)phenyl]amine, tert-octylated N-phenyl-1-naphthylamine, a mixture of monoand dialkylated tert-butyl/tert-octyldiphenylamines, a mixture of mono- and dialkylated nonyldiphenylamines, a mixture of mono- and dialkylated dodecyldiphenylamines, a mixture of mono- and dialkylated isopropyl/isohexyldiphenylamines, a mixture of mono- and dialkylated tert-butyldiphenylamines, 2,3-dihydro-3,3-dimethyl-4H-1,4-benzothiazine, phenothiazine, a mixture of mono- and dialkylated tert-butyl/tert-octylphenothiazines, a mixture of mono- and dialkylated tert-octyl-phenothiazines, N-allylphenothiazine, N,N,N′,N′-tetraphenyl-1,4-diaminobut-2-ene.

2. UV Absorbers and Light Stabilizers

2.1. 2-(2′-Hydroxyphenyl)benzotriazoles, for example 2-(2′-hydroxy-5′-methylphenyl)-benzotriazole, 2-(3′,5′-di-tert-butyl-2′-hydroxyphenyl)benzotriazole, 2-(5′-tert-butyl-2′-hydroxyphenyl)benzotriazole, 2-(2′-hydroxy-5′-(1,1,3,3-tetramethylbutyl)phenyl)benzotriazole, 2-(3′,5′-di-tert-butyl-2′-hydroxyphenyl)-5-chloro-benzotriazole, 2-(3′-tert-butyl-2′-hydroxy-5′-methylphenyl)-5-chloro-benzotriazole, 2-(3′-sec-butyl-5′-tert-butyl-2′-hydroxyphenyl)benzotriazole, 2-(2′-hydroxy-4′-octyloxyphenyl)benzotriazole, 2-(3′,5′-di-tert-amyl-2′-hydroxyphenyl)benzotriazole, 2-(3′,5′-bis-(α,α-dimethylbenzyl)-2′-hydroxyphenyl)benzotriazole, 2-(3′-tert-butyl-2′-hydroxy-5′-(2-octyloxycarbonylethyl)phenyl)-5-chloro-benzotriazole, 2-(3′-tert-butyl-5′-[2-(2-ethylhexyloxy)-carbonylethyl]-2′-hydroxyphenyl)-5-chloro-benzotriazole, 2-(3′-tert-butyl-2′-hydroxy-5′-(2-methoxycarbonylethyl)phenyl)-5-chloro-benzotriazole, 2-(3′-tert-butyl-2′-hydroxy-5′-(2-methoxycarbonylethyl)phenyl)benzotriazole, 2-(3′-tert-butyl2′-hydroxy-5′-(2-octyloxycarbonylethyl)phenyl)benzotriazole, 2-(3′-tert-butyl-5′-[2-(2-ethylhexyloxy)carbonylethyl]-2′-hydroxyphenyl)benzotriazole, 2-(3′-dodecyl-2′-hydroxy-5′-methylphenyl)benzotriazole, 2-(3′-tert-butyl-2′-hydroxy-5′-(2-isooctyloxycarbonylethyl)phenylbenzotriazole, 2,2′-methylene-bis[4-(1,1,3,3-tetramethylbutyl)-6-benzotriazole-2-ylphenol]; the transesterification product of 2-[3′-tert-butyl-5′-(2-methoxycarbonylethyl)-2′-hydroxyphenyl]-2H-benzotriazole with polyethylene glycol 300;

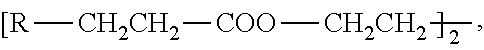

where R=3′-tert-butyl-4′-hydroxy-5′-2H-benzotriazol-2-ylphenyl, 2-[2′-hydroxy-3′-(α,α-dimethylbenzyl)-5′-(1,1,3,3-tetramethylbutyl)-phenyl]benzotriazole; 2-[2′-hydroxy-3′-(1,1,3,3-tetramethylbutyl)-5′-(α,α-dimethylbenzyl)-phenyl]benzotriazole.

2.2. 2-Hydroxybenzophenones, for example the 4-hydroxy, 4-methoxy, 4-octyloxy, 4-decyloxy, 4-dodecyloxy, 4-benzyloxy, 4,2′,4′-trihydroxy and 2′-hydroxy-4,4′-dimethoxy derivatives.

2.3. Esters of substituted and unsubstituted benzoic acids, for example 4-tert-butyl-phenyl salicylate, phenyl salicylate, octylphenyl salicylate, dibenzoyl resorcinol, bis(4-tert-butylbenzoyl)resorcinol, benzoyl resorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butylphenyl 3,5-di-tert-butyl-4-hydroxybenzoate.

2.4. Acrylates, for example ethyl α-cyano-β,β-diphenylacrylate, isooctyl α-cyano-β,β-diphenylacrylate, methyl α-carbomethoxycinnamate, methyl α-cyano-p-methyl-p-methoxy-cinnamate, butyl α-cyano-β-methyl-β-methoxy-cinnamate, methyl α-carbomethoxy-p-methoxy-cinnamate, N-(β-carbomethoxy-p-cyanovinyl)-2-methylindoline, neopentyl tetra(α-cyano-β,β-diphenylacrylate.

2.5. Sterically hindered amines, for example 1,6-Hexanediamine N, N′-bis(1-propyloxy-2,2,6,6-tetramethyl-4-piperidinyl)-N, N′-bis-2-[4,5-bis-(N-n-butyl-N′-1-propyloxy-2,2,6,6-tetramethyl-4-piperidinyl)-1,3,5-triazine], 1,6-Hexanediamine N, N′-bis(2,2,6,6-tetramethyl-4-piperidinyl)-N, N′-bis-2-[4,5-bis-(N-n-butyl-N′-2,2,6,6-tetramethyl-4-piperidinyl)-1,3,5-triazine], carbonic acid bis(1-undecyloxy-2,2,6,6-tetramethyl-4-piperidyl)ester, bis(2,2,6,6-tetramethyl-4-piperidyl)sebacate, bis(2,2,6,6-tetramethyl-4-piperidyl)succinate, bis(1,2,2,6,6-pentamethyl-4-piperidyl)sebacate, bis(1-octyloxy-2,2,6,6-tetramethyl-4-piperidyl)sebacate, bis(1,2,2,6,6-pentamethyl-4-piperidyl) n-butyl-3,5-di-tert-butyl-4-hydroxybenzylmalonate, the condensate of 1-(2-hydroxyethyl)-2,2,6,6-tetramethyl-4-hydroxypiperidine and succinic acid, linear or cyclic condensates of N,N′-bis(2,2,6,6-tetramethyl-4-piperidyl)hexamethylenediamine and 4-tert-octylamino-2,6-dichloro-1,3,5-triazine, tris(2,2,6,6-tetramethyl-4-piperidyl)nitrilotriacetate, tetrakis(2,2,6,6-tetramethyl-4-piperidyl)-1,2,3,4-butanetetracarboxylate, 1,1′-(1,2-ethanediyl)-bis(3,3,5,5-tetramethylpiperazinone), 4-benzoyl-2,2,6,6-tetramethylpiperidine, 4-stearyloxy-2,2,6,6-tetramethylpiperidine, bis(1,2,2,6,6-pentamethylpiperidyl)-2-n-butyl-2-(2-hydroxy-3,5-di-tert-butylbenzyl)malonate, 3-n-octyl-7,7,9,9-tetramethyl-1,3,8-triazaspiro[4.5]decane-2,4-dione, bis(1-octyloxy-2,2,6,6-tetramethylpiperidyl)sebacate, bis(1-octyloxy-2,2,6,6-tetramethylpiperidyl)succinate, linear or cyclic condensates of N,N′-bis(2,2,6,6-tetramethyl-4-piperidyl)hexamethylenediamine and 4-morpholino-2,6-dichloro-1,3,5-triazine, the condensate of 2-chloro-4,6-bis(4-n-butylamino-2,2,6,6-tetramethylpiperidyl)-1,3,5-triazine and 1,2-bis(3-aminopropylamino)ethane, the condensate of 2-chloro-4,6-di-(4-n-butylamino-1,2,2,6,6-pentamethylpiperidyl)1,3,5-triazine and 1,2-bis(3-aminopropylamino)ethane, 8-acetyl-3-dodecyl-7,7,9,9-tetramethyl-1,3,8-triazaspiro[4.5]decane-2,4-dione, 3-dodecyl-1-(2,2,6,6-tetramethyl-4-piperidyl)pyrrolidine-2,5-dione, 3-dodecyl-1-(1,2,2,6,6-pentamethyl-4-piperidyl)pyrrolidine2,5-dione, a mixture of 4-hexadecyloxy- and 4-stearyloxy-2,2,6,6-tetramethylpiperidine, a condensate of N,N′-bis(2,2,6,6-tetramethyl-4-piperidyl)hexamethylenediamine and 4-cyclohexylamino-2,6-dichloro-1,3,5-triazine, a condensate of 1,2-bis(3-aminopropylamino)ethane and 2,4,6-trichloro-1,3,5-triazine as well as 4-butylamino-2,2,6,6-tetramethylpiperidine (CAS Reg. No. [136504-96-6]); a condensate of 1,6-hexanediamine and 2,4,6-trichloro-1,3,5-triazine as well as N,N-dibutylamine and 4-butylamino-2,2,6,6-tetramethylpiperidine (CAS Reg. No. [192268-64-7]); N-(2,2,6,6-tetramethyl-4-piperidyl)-n-dodecylsuccinimide, N-(1,2,2,6,6-pentamethyl-4-piperidyl)-n-dodecylsuccinimide, 2-undecyl-7,7,9,9-tetramethyl-1-oxa-3,8-diaza-4-oxo-spiro[4,5]decane, a reaction product of 7,7,9,9-tetramethyl-2-cycloundecyl-1-oxa-3,8-diaza-4-oxospiro-[4,5]decane and epichlorohydrin, 1,1-bis(1,2,2,6,6-pentamethyl-4-piperidyloxycarbonyl)-2-(4-methoxyphenyl)ethene, N,N′-bis-formyl-N,N′-bis(2,2,6,6-tetramethyl-4-piperidyl)hexamethylenediamine, a diester of 4-methoxymethylenemalonic acid with 1,2,2,6,6-pentamethyl-4-hydroxypiperidine, poly[methylpropyl-3-oxy-4-(2,2,6,6-tetramethyl-4-piperidyl)]siloxane, a reaction product of maleic acid anhydride-α-olefin copolymer with 2,2,6,6-tetramethyl-4-aminopiperidine or 1,2,2,6,6-pentamethyl-4-aminopiperidine, 2,4-bis[N-(1-cyclohexyloxy-2,2,6,6-tetramethylpiperidine-4-yl)-N-butylamino]-6-(2-hydroxyethyl)amino-1,3,5-triazine, 1-(2-hydroxy-2-methylpropoxy)-4-octadecanoyloxy-2,2,6,6-tetramethylpiperidine, 5-(2-ethylhexanoyl)oxymethyl-3,3,5-trimethyl-2-morpholinone, Sanduvor (Clariant; CAS Reg. No. 106917-31-1], 5-(2-ethylhexanoyl)oxymethyl-3,3,5-trimethyl-2-morpholinone, the reaction product of 2,4-bis[(1-cyclohexyloxy-2,2,6,6-piperidine-4-yl)butylamino]-6-chloro-s-triazine with N,N′-bis(3-aminopropyl)ethylenediamine), 1,3,5-tris(N-cyclohexyl-N-(2,2,6,6-tetramethylpiperazine-3-one-4-yl)amino)-s-triazine, 1,3,5-tris(N-cyclohexyl-N-(1,2,2,6,6-pentamethylpiperazine-3-one-4-yl)amino)-s-triazine,

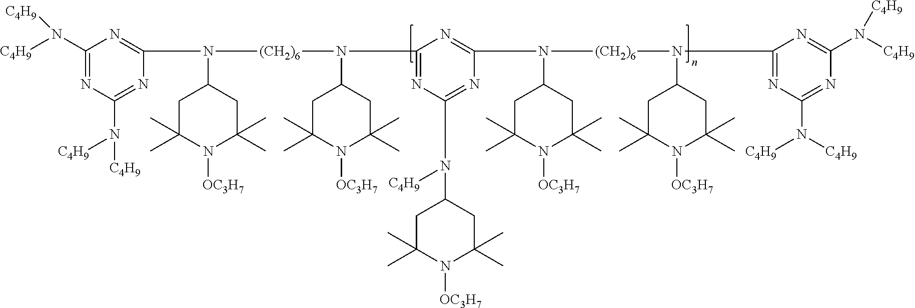

2.6 Benzoxazinone derivatives such as e.g. 2,2′-(1,4-phenylene)bis[4H-3,1-benzoxazin-4-one] (CAS No. 018600-59-4).

2.7. Oxamides, for example 4,4′-dioctyloxyoxanilide, 2,2′-diethoxyoxanilide, 2,2′-dioctyloxy5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxamide, 2-ethoxy-5-tert-butyl-2′-ethoxanilide and its mixture with 2-ethoxy-2′-ethyl-5,4′-di-tert-butoxanilide, mixtures of o- and β-methoxy-disubstituted oxanilides and mixtures of o- and p-ethoxy-disubstituted oxanilides.

2.8. 2-(2-Hydroxyphenyl)-1,3,5-triazines, for example 2,4,6-tris(2-hydroxy-4-octyloxyphenyl)1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)1,3,5-triazine, 2-[2-hydroxy-4-(2-hydroxy-3-butyloxypropoxy)phenyl]-4,6-bis(2,4-dimethyl)1,3,5-triazine, 2-[2-hydroxy-4-(2-hydroxy-3-octyloxypropyloxy)phenyl]-4,6-bis(2,4-dimethyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 2-[2-hydroxy-4-(2-hydroxy-3-dodecyloxypropoxy)phenyl]-4,6-bis(2,4-dimethylphenyl)-1,3,5-triazine, 2-(2-hydroxy-4-hexyloxy)phenyl4,6-diphenyl-1,3,5-triazine, 2-(2-hydroxy-4-methoxyphenyl)-4,6-diphenyl-1,3,5-triazine, 2,4,6-tris[2-hydroxy-4-(3-butoxy-2-hydroxypropoxy)phenyl]-1,3,5-triazine, 2-(2-hydroxyphenyl)-4-(4-methoxyphenyl)-6-phenyl-1,3,5-triazine, 2-{2-hydroxy-4-[3-(2-ethylhexyl-1-oxy)-2-hydroxypropyloxy]phenyl}-4,6-bis(2,4-dimethylphenyl)-1,3,5-triazine, 2,4-bis(4-[2-ethylhexyloxy]-2-hydroxyphenyl)-6-(4-methoxyphenyl)-1,3,5-triazine, 2-(4,6-bis-biphenyl-4-yl-1,3,5-triazin-2-yl)-5-(2-ethyl-(n)-hexyloxy)phenol.

3. Metal deactivators, for example N,N′-diphenyloxamide, N-salicylal-N′-salicyloyl hydrazine, N,N′-bis(salicyloyl)hydrazine, N,N′-bis(3,5-di-tert-butyl-4-hydroxyphenylpropionyl)hydrazine, 3-salicyloylamino-1,2,4-triazole, bis(benzylidene)oxalyl dihydrazide, oxanilide, isophthaloyl dihydrazide, sebacoyl bisphenylhydrazide, N,N′-diacetyladipoyl dihydrazide, N,N′-bis(salicyloyl)oxalyl dihydrazide, N,N′-bis(salicyloyl)thiopropionyl dihydrazide.

3a. Formamidines, for example Ethoxycarbonylphenyl)-N′-ethyl-N′-phenyl formamidine.

4. Phosphites and phosphonites, for example triphenyl phosphite, diphenylalkyl phosphites, phenyldialkyl phosphites, tris(nonylphenyl) phosphite, trilauryl phosphite, trioctadecyl phosphite, distearylpentaerythritol diphosphite, tris(2,4-di-tert-butylphenyl) phosphite, diisodecyl pentaerythritol diphosphite, bis(2,4-di-tert-butylphenyl)pentaerythritol diphosphite, bis(2,4-di-cumylphenyl)pentaerythritol diphosphite, bis(2,6-di-tert-butyl-4-methylphenyl)pentaerythritol diphosphite, diisodecyloxypentaerythritol diphosphite, bis(2,4-di-tert-butyl-6-methylphenyl)pentaerythritol diphosphite, bis(2,4,6-tris(tert-butylphenyl)pentaerythritol diphosphite, tristearyl sorbitol triphosphite, tetrakis(2,4-di-tert-butylphenyl) 4,4′-biphenylene diphosphonite, [3,3′,5,5′-tetra-tert. butyl-1,1′biphenyl-2,2′-diyl]-[3-(3-methyl-4-hydroxy-5-tert.butyl-phenyl)-propyl]-phosphite, 6-isooctyloxy-2,4,8,10-tetra-tert-butyl-12H-dibenz[d,g]-1,3,2-dioxaphosphocin, bis(2,4-di-tert-butyl-6-methylphenyl)methyl phosphite, bis(2,4-di-tert-butyl-6-methylphenyl)ethyl phosphite, tris-[4-tert. butyl-2-(5-tert. butyl-3H-1-benzofuran-2-one)-phenyl]-phosphite, tris-[4-(1,1′3,3′-tetramethyl-butane)-2-(5-(1,1′3,3′-tetramethyl-butane-3H-1-benzofuran-2-one)-phenyl]-phosphite, tris-[2,6-dimethyl-(5,7-di-tert. butyl)-3H-1-benzofuran-2-one)-phenyl]-phosphite, bis-[2,6-dimethyl-(5,7-di-tert. butyl)-3H-1-benzofuran-2-one)-phenyl]-phenyl-phosphite, bis-[2,6-dimethyl-(5,7-di-tert. butyl)-3H-1-benzofuran-2-one)-phenyl]-[2,4-di-tert. butyl-phenyl]-phosphite, [3,3′,5,5′-tetra-tert. butyl-1,1′biphenyl-2,2′-diyl]-[4-tert. butyl-(5-tert. butyl)-3H-1-benzofuran-2-one)-phenyl]-phosphite, [3,3′,5,5′-tetra-tert. butyl-1,1′biphenyl-2,2′-diyl]-[2,6-dimethyl-(5,7-di-tert. butyl)-3H-1-benzofuran-2-one)-phenyl]-phosphite, [2,2′-methylene-bis-(4,6-di-tert. butyl-phenyl)-1,1′-diyl]-[1,6-dimethyl-4-(5,7-di-tert. butyl)-3H-1-benzofuran-2-one)-phenyl]-phosphite, [2,2′-ethylene-bis-(4,6-di-tert. butyl-phenyl)-1,1′-diyl]-[1,6-dimethyl-4-(5,7-di-tert. butyl)-3H-1-benzofuran-2-one)-phenyl]-phosphite, [2,2′-ethylene-bis-(4,6-di-tert. butyl-phenyl)-1,1′-diyl]-[1-methyl-6-tert. butyl-4-(5,7-di-tert. butyl)3H-1-benzofuran-2-one)-phenyl]-phosphite, bis-(2,6-dimethyl-(5,7-di-tert. butyl)-3H-1-benzofuran-2-one)-phenol) pentaerythritol diphosphite, bis-(1-methyl-6-tert. butyl-(5,7-di-tert. butyl)-3H-1-benzofuran-2-one)-phenol) pentaerythritol diphosphite, bis-(4-tert. butyl-(5-tert. butyl)-3H-1-benzofuran-2-one)-phenol) pentaerythritol diphosphite, bis-(4-(1,1′3,3′-tetramethyl-butane)-(5-(1,1′3,3′-tetramethyl-butane))-3H-1-benzofuran-2-one)-phenol) pentaerythritol diphosphite, 6-fluoro-2,4,8,10-tetra-tert-butyl-12-methyl-dibenz[d,g]-1,3,2-dioxaphosphocin, 2,2′,2″-nitrilo[triethyltris(3,3′,5,5′-tetra-tert-butyl-1,1′-biphenyl-2,2′-diyl)phosphite], 2-ethylhexyl(3,3′,5,5′-tetra-tert-butyl-1,1′-biphenyl-2,2′-diyl)phosphite, 5-butyl-5-ethyl-2-(2,4,6-tri-tert-butylphenoxy)-1,3,2-dioxaphosphirane.

The following phosphites are especially preferred:

Tris(2,4-di-tert-butylphenyl)phosphite (Irgafos®168, Ciba Specialty Chemicals Inc.), tris(nonylphenyl) phosphite, phosphorus acid mixed 2,4-bis(1,1-dimethylpropyl)phenyl and 4-(1,1-dimethylpropyl)phenyl triesters (CAS Reg. No. 939402-02-5), phosphorous acid triphenyl ester polymer with alpha-hydro-omega-hydroxypoly[oxy(methyl-1,2-ethanediyl) C10-16 alkyl esters (CAS Reg. No. 1227937-46-3).

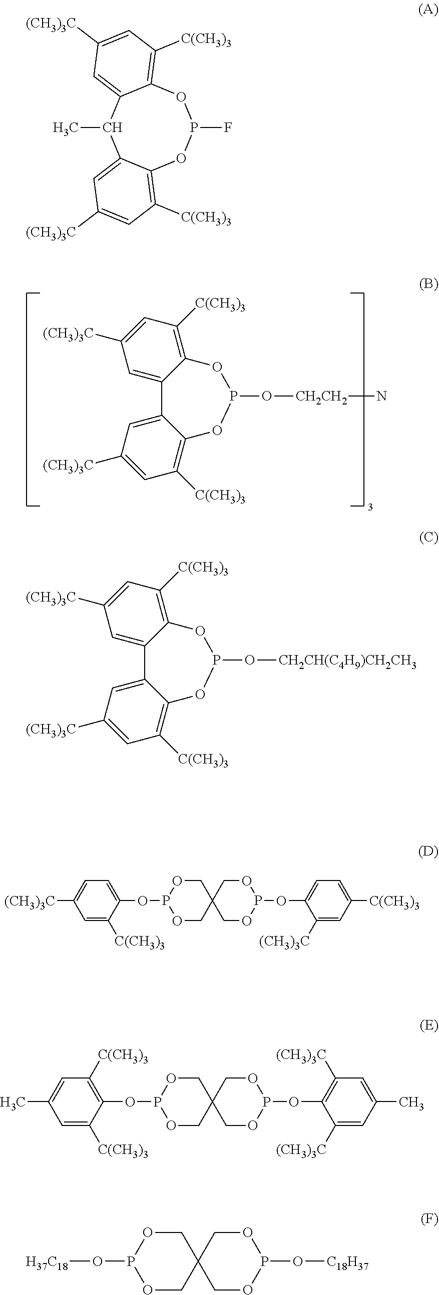

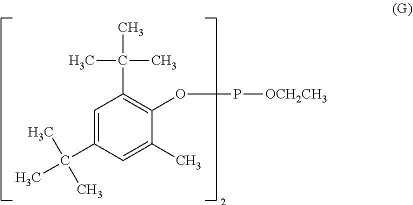

[2,2′-ethylene-bis-(4,6-di-tert. butyl-phenyl)-1,1′-diyl]-[1,6-dimethyl-4-(5,7-di-tert. butyl)3H-1-benzofuran-2-one)-phenyl]-phosphite, [2,2′-ethylene-bis-(4,6-di-tert. butyl-phenyl)1,1′-diyl]-[1-methyl-6-tert. butyl-4-(5,7-di-tert. butyl)-3H-1-benzofuran-2-one)-phenyl]-phosphite, [3,3′,5,5′-tetra-tert. butyl-1,1′biphenyl-2,2′-diyl]-[3-(3-methyl-4-hydroxy-5-tert.butyl-phenyl)-propyl]-phosphite.

5. Hydroxylamines, for example N,N-dibenzylhydroxylamine, N,N-diethylhydroxylamine, N,N-dioctylhydroxylamine, N,N-dilaurylhydroxylamine, N,N-ditetradecylhydroxylamine, N,N-dihexadecylhydroxylamine, N,N-dioctadecylhydroxylamine, N-hexadecyl-N-octadecylhydroxylamine, N-heptadecyl-N-octadecylhydroxylamine, N,N-dialkylhydroxylamine derived from hydrogenated tallow amine, N-octadecylhydroxylamine, N,N-dialkylhydroxylamine, N,N-di-tert-butylhydroxylamine, N-cyclohexylhydroxylamine, N-cyclododecylhydroxylamine, N,N-dicyclohexylhydroxylamine, N,N-didecylhydroxylamine, N,N-di(coco alkyl)hydroxylamine, N,N-di(C₂₀-C₂₂alkyl)hydroxylamine, N-heptatriacontyl-N-octadecylhydroxylamine.

6. Amine oxides, for example N,N-dibenzylhydroxylamine oxide, N,N-diethylhydroxylamine oxide, N,N-dioctylhydroxylamine oxide, N,N-dilaurylhydroxylamine oxide, N,N-ditetradecylhydroxylamine oxide, N,N-dihexadecylhydroxylamine oxide, N,N-dioctadecylhydroxylamine oxide, N-hexadecyl-N-octadecylhydrox-ylamine oxide, N-heptadecyl-N-octadecylhydroxylamine oxide, N,N-dialkylhydroxylamine oxide derived from hydrogenated tallow amine, amines, bis(hydrogenated rape-oil alkyl)methyl, N-oxides.

7. Nitrones, for example, N-benzyl-alpha-phenylnitrone, N-ethyl-alpha-methylnitrone, N-octyl-alpha-heptylnitrone, N-lauryl-alpha-undecylnitrone, N-tetradecyl-alpha-tridecylnnitrone, N-hexadecyl-alpha-pentadecylnitrone, N-octadecyl-alpha-heptadecylnitrone, N-hexadecyl-alpha-heptadecylnitrone, N-ocatadecyl-alpha-pentadecylnitrone, N-heptadecyl-alpha-heptadecylnitrone, N-octadecyl-alpha-hexadecylnitrone, nitrone derived from N,N-dialkylhydroxylamine derived from hydrogenated tallow amine.

8. Thiosynergists, for example dilauryl thiodipropionate, dimistryl thiodipropionate, distearyl thiodipropionate, pentaerythritol tetrakis[3-(dodecylthio)propionate] or distearyl disulfide.

9. Peroxide scavengers, for example esters of β-thiodipropionic acid, for example the lauryl, stearyl, myristyl or tridecyl esters, mercaptobenzimidazole or the zinc salt of 2-mercaptobenzimidazole, zinc dibutyldithiocarbamate, dioctadecyl disulfide, pentaerythritol tetrakis(β-dodecylmercapto)propionate.

10. Basic co-stabilizers, for example melamine, polyvinylpyrrolidone, dicyandiamide, triallyl cyanurate, urea derivatives, hydrazine derivatives, amines, polyamides, polyurethanes, alkali metal salts and alkaline earth metal salts of higher fatty acids, for example calcium stearate, zinc stearate, magnesium behenate, magnesium stearate, sodium ricinoleate and potassium palmitate, antimony pyrocatecholate or zinc pyrocatecholate, zeolithes, hydrotalcites, hydrocalumites.

11. Nucleating agents, for example inorganic substances, such as talcum, metal oxides, such as titanium dioxide or magnesium oxide, phosphates, carbonates or sulfates of, preferably, alkaline earth metals; organic compounds, such as mono- or polycarboxylic acids and the salts thereof, e.g. 4-tert-butylbenzoic acid, adipic acid, diphenylacetic acid, sodium succinate or sodium benzoate; polymeric compounds, such as ionic copolymers (ionomers). Especially preferred are 1,3:2,4-bis(3′,4′-dimethylbenzylidene)sorbitol, 1,3:2,4-di(paramethyldibenzyli-dene)sorbitol, and 1,3:2,4-di(benzylidene)sorbitol. Beta-nucleating agents are also of interest.

12. Fillers and reinforcing agents, for example calcium carbonate, silicates, glass fibres, carbon fibers, glass beads, asbestos, talcum (preferably with a particle size of 0.01 to 20 m), kaolin, mica, barium sulfate, metal oxides and hydroxides, carbon black, graphite, wood flour and flours or fibers of other natural products, synthetic fibers.

13. Other additives, for example plasticisers, lubricants, emulsifiers, pigments, rheology additives, catalysts, flow-control agents, optical brighteners, flameproofing agents, antistatic agents and blowing agents.

14. Benzofuranones and indolinones, for example those disclosed in U.S. Pat. Nos. 4,325,863; 4,338,244; 5,175,312; 5,216,052; 5,252,643; DE-A-4316611; DE-A-4316622; DE-A-4316876; EP-A-0589839, EP-A-0591102; EP-A-1291384 or 3-[4-(2-acetoxyethoxy)phenyl]-5,7-di-tert-butylbenzofuran-2-one, 5,7-di-tert-butyl-3-[4-(2-stearoyloxyethoxy)phenyl]benzofuran-2-one, 3,3′-bis[5,7-di-tert-butyl-3-(4-[2-hydroxyethoxy]phenyl)benzofuran-2-one], 5,7-di-tert-butyl-3-(4-ethoxyphenyl)benzofuran-2-one, 3-(4-acetoxy-3,5-dimethylphenyl)-5,7-di-tert-butylbenzofuran-2-one, 3-(3,5-dimethyl-4-pivaloyloxyphenyl)-5,7-di-tert-butylbenzofuran-2-one, 3-(3,4-dimethylphenyl)-5,7-di-tert-butylbenzofuran-2-one, 3-(2,3-dimethylphenyl)-5,7-di-tert-butylbenzofuran-2-one, 3-(2-acetyl-5-isooctylphenyl)-5-isooctylbenzofuran-2-one.

The weight ratio of the present component (a) to the total amount of the conventional additive(s) can be for example 100:1 to 1:1000 or 10:1 to 1:100 or 20:1 to 1:20 or 10:1 to 1:10.

The conventional additive may be present in the polyolefin composition according to the present invention in an amount of e.g. 0.001 to 30%, especially 0.001 to 20%, relative to the weight of the polyolefin. Preferred is an amount of 0.1 to 20%.

Components (a), (b) and (c) as well as optional further additives of the invention may readily be incorporated into the polyolefin by conventional techniques, at any convenient stage prior to the manufacture of shaped articles therefrom.

Components (a), (b) and (c) may be added together or successively, if desired at different stages of processing the polyolefin.

Components (a), (b) and (c) as well as optional further additives can judiciously be incorporated by one of the following methods:
as emulsion or dispersion
as a dry mixture during the blending
by direct introduction into the processing apparatus (e.g. extruders, internal mixers)
as melt.

Incorporation of components (a), (b) and (c) as well as optional further additives is performed best in a thermal compounding step. Thorough blending of components (a), (b) and (c) as well as optional further additives may be followed by an extrusion of the physical blend at elevated temperature. Typically, an extruder with suitable screw configuration is used for this step.

Components (a), (b) and (c) as well as optional further additives of the invention can also be added to the polyolefin in the form of a masterbatch (‘concentrate’), which contains components (a), (b) and (c) as well as optional further additives of the invention incorporated in a further polymer of the masterbatch, like in polyethylene or polypropylene. The concentration for the sum of additives in such masterbatch is, for example, from 1% to 90%, preferably 1% to 40%, and in particular 2.5% to 25% by weight of the masterbatch. The polymer, like polyethylene or polypropylene, may be present in such masterbatch in a concentration of 10% to 99%, preferably 60% to 99%, and in particular 75% to 97.5%. Said polymer of the masterbatch must not be necessarily a polyolefin, like polyethylene or polypropylene. The masterbatch can for example be in the form of a powder, granules, dispersions or in the form of latices.

The polyolefin compositions of this invention can be employed in various forms and/or processed to give various final products, for example as to obtain films, fibres, tapes, moulding compositions or profiles.

In more detail, the final product respectively article can be any type of polymeric article, which needs stabilization in natural sunlight and/or humidity at low, ambient or elevated temperature and/or the flame-retardancy of which shall be improved.

Examples of such articles are plastic films in general (packaging, dump, laminating, swimming pools covers, waste bags, wallpaper, stretch and shrink wrap, raffia, desalination film, batteries, and connectors), and also agricultural films (greenhouse covers, tunnel, mulch, silage, bale wrap), especially in presence of intensive application of agrochemicals.

The polymeric articles may be manufactured by any process available to those of ordinary skill in the art including, but not limited to, extrusion, extrusion blowing, film casting, film blowing, calendering, injection molding, blow molding, compression molding, thermoforming, spinning, blow extrusion or rotational casting.

For the production of the desired polymeric article out of the polymer compositions of this invention, any appropriate equipment can be used, depending on the final form of the article, for example a blow extruder in the case of films, an extrusion machine in the case of sheets or an injection molding machine.

Thus, another embodiment of the present invention is an article made of an inventive composition as described above. A polyolefin article for agricultural use, preferably a thin film, typically obtained with the blow extrusion technology, is preferred. A monolayer film or a multilayer film of three, five or seven layers, preferably of a thickness of 180 microns or 120 microns, typically 60 to 180 microns, is of particular interest. The most important application of thin plastic films in agriculture is as covers for greenhouses and tunnels to grow crops in a protected environment.

A multilayer polyolefin film is also preferred.

Such a multilayer film is typically made of three, five or seven layers. This can lead to a film structure like A-B-A, A-B-C, A-B-C-B-A, A-B-C-B-D, A-B-C-D-C-B-A or A-A-B-C-B-A-A. A, B, C, D represent the different polymers and tackifiers mentioned in the following.

However, adjacent layers can also be coupled so that the final film article can be made of an even number of layers, i.e. two, four or six layers such as A-A-B-A, A-A-B-B, A-A-B-A-A, AB-B-A-A, A-A-B-C-B, A-A-B-C-A-A and the like.

The composition according to the present invention is particularly useful for stabilizing greenhouse film covers, which are in contact with an agrochemical compound such as e.g. Metam-Sodium (Sodium N-methyldithiocarbamate), Cymoxanil (2-Cyan-N-[(ethylamino)carbonyl]-2-(methoxyimino)acetamide), Thiram (Bis(dimethylthiocarbamoyl)disulfide), Mancozeb (Mn—Zn-ethylenebis(dithiocarbamate)) or elemental sulfur, in particular elemental sulfur or Metam-Sodium.

Thus, a further embodiment of the present invention is a greenhouse polyolefin film cover which is in contact with an agrochemical compound.

Still a further embodiment of the present invention is a method for stabilizing a polyolefin against degradation induced by light, heat, oxidation or the effect of agrochemical compounds, which comprises incorporating into the polyolefin components (a), (b) and (c) as defined above.

Furthermore, the mixture of components (a), (b) and (c) can impart flame-retardancy to polyolefins. Therefore, a further embodiment of the present invention are flame-retardant articles comprising an inventive composition as defined hereinbefore.

An additional embodiment of this invention is directed to the use of components (b) and (c) for reducing odor in a polyolefin composition comprising a component (a), wherein the definitions and preferences for components (a), (b) and (c), as well as for the polyolefin, as given hereinbefore shall apply.

It was found that polyolefin compositions comprising component (a) may show a specific odor, which could be attributed to butyric acid. Surprisingly, the odor can be significantly reduced by use of components (b) and (c).

The following examples illustrate the invention in greater detail. All percentages and parts are by weight, unless stated otherwise.

### EXAMPLES

### Examples 1 to 9

A) Components Used Polypropylene Polymer: Moplen HP552R, manufacturer LyondellBasell Industries N.V.

Component (a1): Compound of formula (1), available as Flamestab® NOR 116 FF, manufacturer BASF SE.

Component (b1): Magnesium aluminium hydroxide carbonate hydrate, available as DHT-4V® from Kisuma Chemicals B.V..

Component (b2): Calcium oxide (available as Kezadol DAB from Kettlitz-Chemie GmbH & Co. KG).

Component (c1): N,N-Dioctadecylhydroxylamine, available as Irgastab® FS 042 from BASF SE.

Component (c2): N-methyl dioctadecyl amine oxide

B) Preparation of Pellets and Tests

Polypropylene Polymer Moplen HP552R (in the following designated as PP) and the respective components given in the following Table 1 are dry blended in the amounts as indicated in Table 1 and then melt compounded into pellets on a DSM Twin-screw Micro-Compounder R at a temperature Tₘₐₓ of 230° C.

The butyric acid, source of generated odor, is evaluated in each of the produced pelletized compositions according to a thermal desorption GC-MS method.

According to the thermal desorption GC-MS method the butyric acid is extracted by thermal desorption from the specimen pellet and subsequently quantified by GC-MS analysis.

The results obtained are given in the following Table 1.

TABLE 1

| | Composition | Butyric acid |
|---|---|---|
| Example | (in weight-%) | (in ppm) |
| 1 (comparative) | 80% PP + 20.0% (a1) | 596 |
| 2 (comparative) | 80% PP + 18.7% (a1) + | 75 |
| | 1.3% (b1) | |
| 3 (comparative) | 80% PP + 18.7% (a1) + | 65 |
| | 1.3% (b2) | |
| 4 (comparative) | 80% PP + 18.7% (a1) + | 465 |
| | 1.3% (c1) | |
| 5 (according to invention) | 80% PP + 18.7% (a1) + | 42 |
| | 0.6% (b1) + 0.7% (c1) | |
| 6 (according to invention) | 80% PP + 18.7% (a1) + | 15 |
| | 0.6% (b2) + 0.7% (c1) | |
| 7 (comparative) | 80% PP + 18.7% (a1) + | 591 |
| | 1.3% (c2) | |
| 8 (according to invention) | 80% PP + 18.7% (a1) + | 16 |
| | 0.6% (b1) + 0.7% (c2) | |
| 9 (according to invention) | 80% PP + 18.7% (a1) + | 11 |
| | 0.6% (b2) + 0.7% (c2) | |

The results in the above Table 1 clearly show that the inventive combination of components significantly reduces the amount of odor contributing butyric acid.

1. A polyolefin composition comprising
(a) a compound of formula 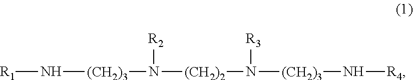
wherein R₁ and R₂ are a group of formula 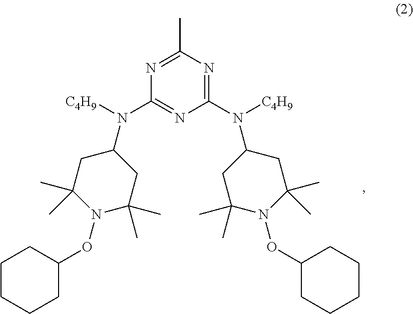
and one of R₃ and R₄ is hydrogen and the remaining one of R₃ and R₄ is a group of formula (2),
(b) a hydrotalcite or an inorganic oxide, or mixtures thereof, and
(c) a hydroxylamine stabilizer or amine oxide stabilizer.

2. A composition according to claim 1, wherein component (b) is a magnesium aluminum hydroxide carbonate hydrate or zinc aluminum hydroxide carbonate hydrate.

3. A composition according to claim 2, wherein component (b) is a magnesium aluminum hydroxide carbonate hydrate.

4. A composition according to claim 1, wherein component (b) is calcium oxide, magnesium oxide or zinc oxide.

5. A composition according to claim 4, wherein component (b) is calcium oxide.

6. A composition according to claim 1, wherein component (c) is a compound of formula 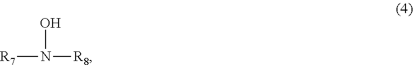
wherein R₇ and R₈ independently of each other, are C₁-C₃₀ alkyl or benzyl.

7. A composition according to claim 6, wherein R₇ and R₈, independently of each other, are C₁₆-C₁₈alkyl.

8. A composition according to claim 1, wherein component (c) is a compound of formula 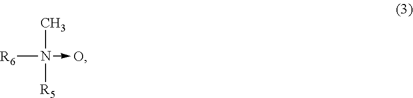
wherein R₅ and R₆, independently of each other, are C1-C₃₀ alkyl

9. A composition according to claim 8, wherein R₅ and R₆, independently of each other, are C₈-C₃₀ alkyl.

10. A composition according to claim 1, wherein the weight ratio of component (a) to component (b) is 500:1 to 1:1.

11. A composition according to claim 1, wherein the weight ratio of component (a) to component (c) is 500:1 to 1:1.

12. A composition according to claim 1, wherein 0.01 to 50 weight-% of component (a) are used, based on the weight of the composition.

13. A composition according to claim 1, wherein the polyolefin is polyethylene or polypropylene or a copolymer thereof.

14. A composition according to claim 13, wherein the polyolefin is polypropylene or a copolymer thereof.

15. A method of making a composition comprising mixing a polyolefin and components (a), (b) and (c) as defined in claim 1.

16. A flame-retardant article comprising a composition as defined in claim 1.
